(19) United States
(12) Patent Application Publication
(10) Pub. No.: US 2026/0032382 A1
(43) Pub. Date: Jan. 29, 2026

(54) POWER MANAGEMENT INTEGRATED CIRCUIT

(71) Applicant: Cirrus Logic International Semiconductor Ltd., Edinburgh (GB)

(72) Inventors: Andrew J. HOWLETT, Edinburgh (GB); Jonathan TAYLOR, London (GB); Gary WONG, Edinburgh (GB)

(73) Assignee: Cirrus Logic International Semiconductor Ltd., Edinburgh (GB)

(21) Appl. No.: 19/254,154

(22) Filed: Jun. 30, 2025

Related U.S. Application Data
(60) Provisional application No. 63/676,475, filed on Jul. 29, 2024.
(60) Provisional application No. 63/767,196, filed on Mar. 5, 2025.

(51) Int. Cl. H04R 3/00; H04R 29/00

(52) U.S. Cl. CPC H04R 3/007; H04R 29/00

(57) ABSTRACT

A power management integrated circuit (PMIC) for a system that comprises a signal path having a plurality of stages, the PMIC comprising: supply generation circuitry for generating supply voltages for the stages of the signal path; and controller circuitry configured to control operation of the supply generation circuitry based on a signal received from the signal path.

### FIELD OF THE INVENTION

The present disclosure relates to a power management integrated circuit for an audio system.

### BACKGROUND

Audio systems of all types, ranging from small consumer devices to large-scale professional audio environments, typically require multiple stages of signal processing to maintain high-fidelity sound reproduction. These stages may include (but are not restricted to): analog gain stages, for amplifying low level analog audio signals prior to conversion into digital signals; analog to digital conversion (ADC) stages, for converting analog input signals into digital output signals for further processing or storage; digital to analog conversion (DAC) stages, for converting digital signals into analog signals for analog playback; and output analog gain stages, for amplifying analog output signals for output to output devices such as headphones or speakers.

Each of these stages requires precise and stable power regulation to function optimally. Traditional power management solutions often provide static power levels, leading to unnecessary energy consumption during periods of low audio activity or when no external devices are connected. This inefficiency is particularly problematic in battery-powered audio devices and large-scale audio installations, where energy savings are critical for performance and cost efficiency.

While power efficiency is a major concern in consumer electronic devices, particularly battery powered devices, it is equally significant in large-scale professional audio systems, including: audio mixing consoles, which are used in recording studios, live concerts, and broadcasting, where multiple input channels are processed simultaneously; theatres and performance venues, where high-fidelity audio is required for multiple microphone and instrument inputs; conference systems and public address (PA) systems, which require adaptive power management to optimise performance based on live input levels; broadcasting and post-production studios, where multiple ADC and DAC stages operate continuously, consuming significant power; and musical instruments and related processing systems such as effects processors (e.g. effects pedals, muti-effects units) and the like.

In such environments, multiple audio channels may be processed simultaneously, leading to high power consumption and increased thermal dissipation, which can affect system performance and longevity. Traditional power regulation methods result in inefficiencies when audio channels are idle or processing low-level signals, unnecessarily drawing full power. For example, conventional power solutions typically supply power to all the stages of an audio signal path continuously, leading to unnecessary power consumption when no input or output device is coupled to the audio signal path, or when an input and/or an output device is coupled to the audio signal path, but no signal is supplied to the audio signal path.

### SUMMARY

According to a first aspect, the invention provides a power management integrated circuit (PMIC) for a system that comprises a signal path having a plurality of stages, the PMIC comprising: supply generation circuitry for generating supply voltages for the stages of the signal path; and controller circuitry configured to control operation of the supply generation circuitry based on a signal received from the signal path.

The supply generation circuitry may comprise a plurality of instances of supply generator circuitry, each instance of supply generator circuitry configured to generate a respective output voltage for use as a supply voltage to a stage of the signal path.

The controller circuitry may be configured to control the output voltage of an instance of supply generator circuitry based on the signal received from the signal path.

The signal received from the signal path may be indicative of a level of an input signal to the signal path.

The controller circuitry may be operative to control a supply voltage to an amplifier stage of the signal path based on the signal received from the signal path.

The controller circuitry may be operative to select a level of the supply voltage from a plurality of discrete supply voltage levels based on the signal received from the signal path.

The controller circuitry may be operative to modulate a level of the supply voltage over a supply voltage range based on the signal received from the signal path.

The controller circuitry may be operative to control a supply voltage to an analog to digital converter (ADC) stage of the signal path based on the signal received from the signal path.

The controller circuitry may be operative to control a supply voltage to a digital to analog converter (DAC) stage of the signal path based on the signal received from the signal path.

The controller circuitry may be operative to control a supply voltage to a component or subsystem of a stage of the signal path biased on the signal received from the signal path.

The PMIC may be configured to control one or more of: a switching frequency of one of the plurality of instances of supply generator circuitry; and a mode of operation of low dropout regulator circuitry of one of the plurality of instances of supply generator circuitry, based on the signal received from the signal path or based on an output voltage of the one of the plurality of instances of supply generator circuitry.

The signal received from the signal path may be indicative of connection of an input device or an output device to the signal path.

The PMIC may be configured to maintain the stages of the signal path in an inactive or low-power state while no input device is connected to the signal path.

The signal received from the signal path may be indicative of an impedance at an input device connector or an output device connector coupled to the signal path.

The controller circuitry may be operative to compare the impedance at the input device connector to a reference impedance to detect that an input device is coupled to the signal path and/or to detect a fault in an input device coupled to the signal path.

The controller circuitry may be operative to compare the impedance at the output device connector to a reference impedance to detect that an output device is coupled to the signal path and/or to detect a fault in an output device coupled to the signal path.

The PMIC may comprise signal activity detector circuitry configured to compare a level of the signal received from the signal path to a predefined threshold to determine if an input device is coupled to the signal path.

The signal received from the signal path may be a signal output by an amplifier stage of the signal path or a signal output by an ADC stage of the signal path.

An instance of supply generator circuitry may be configured to generate: an output voltage for use as a supply voltage to an input device to the signal path; and/or an output voltage for use as a supply voltage to an output device to the signal path.

The signal path may comprise an audio signal path.

According to a second aspect, the invention provides a system comprising the PMIC of the first aspect and an audio signal path

According to a third aspect, the invention provides an integrated circuit comprising the PMIC of the first aspect and an audio signal path.

According to a fourth aspect, the invention provides a host device comprising the PMIC of the first aspect.

The host device may comprise, for example: a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console, a VR or AR device, a mobile telephone, a portable audio player or other portable device; an audio mixing console, a public address (PA) system, an audio system of a performance venue, an audio system of a broadcasting or post-production studio, or professional audio system; a musical instrument; or an effects system for a musical instrument.

According to a fifth aspect, the invention provides a power management integrated circuit (PMIC) for a system that comprises a signal path having a plurality of stages, the PMIC comprising: supply generation circuitry for generating supply voltages for the stages of the signal path; and controller circuitry configured to maintain the stages of the signal path in an inactive or low-power state until connection of an input device to the signal path is detected by the controller.

According to a sixth aspect, the invention provides a power management integrated circuit (PMIC) for a system that comprises a plurality of independent signal paths, each independent signal path having a plurality of stages, the PMIC comprising: supply generation circuitry for generating supply voltages for the stages of each signal path; and controller circuitry configured to control operation of the supply generation circuitry, such that the supply voltages for the stages of each signal path of the plurality of signal paths are controllable independently of the supply voltages for the stages of each other signal path of the plurality of signal paths.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a power management integrated circuit (PMIC) according to the present disclosure;

FIG. 2 is a schematic representation of an audio system comprising an audio signal path and the PMIC shown in FIG. 1;

FIG. 3 is a schematic representation of an audio system comprising input stages of an audio signal path and the PMIC of FIG. 1; and

FIG. 4 is a is a schematic representation of an audio system comprising output stages of an audio signal path and the PMIC of FIG. 1.

### DETAILED DESCRIPTION

The present disclosure proposes a power management integrated circuit (PMIC) which is capable of dynamically adjusting supply voltages for individual stages of an audio signal path based on control signals received in real time from the audio signal path.

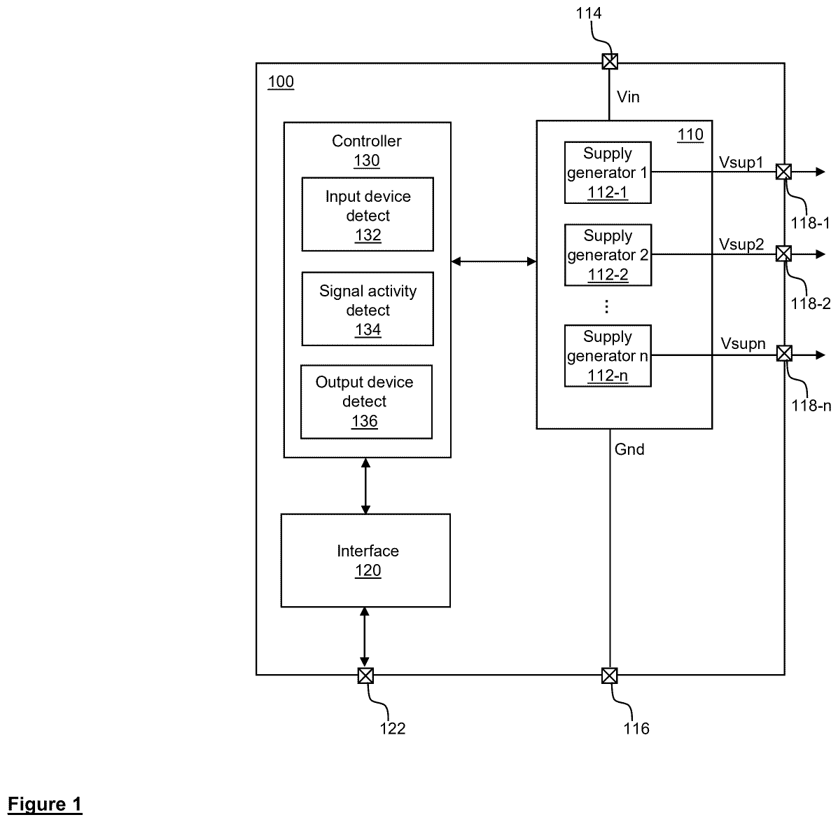

FIG. 1 is a schematic representation of a PMIC according to the present disclosure.

The PMIC, shown generally at 100 in FIG. 1, comprises a supply generation subsystem 110, interface circuitry 120 and controller circuitry 130.

The supply generation subsystem 110 comprises a plurality of instances of supply generator circuitry 112-1-112-n, each configured to receive a positive power supply voltage Vin from a positive power supply connection (e.g. a pin, pad, ball or the like) 114 of the PMIC 100 and a ground or other reference voltage Gnd from a reference voltage supply connection (e.g. a pin, pad, ball or the like) 116 of the PMIC 100.

Each instance of supply generator circuitry 112-1-112-n is configured to generate a respective supply voltage Vsup1-Vsup-n (comprising, for example, positive and negative power supply voltages or rails, or a ground-referenced positive power supply voltage or rail) for use by an external component or subsystem coupled to the PMIC 100, e.g. a stage of an audio signal path, or an individual component or subsystem of such a stage.

Each instance of supply generator circuitry 112-1-112-n comprises power converter circuitry such as, for example, low dropout regulator (LDO) circuitry, switching power converter circuitry such as inductive buck, boost or buck-boost converter circuitry, charge pump circuitry or the like. It will be appreciated by those of ordinary skill in the art that the instances of supply generator circuitry 112-1-112-n may employ different types of power converter circuitry. For example, the first instance of supply generator circuitry 112-1 may comprise power converter circuitry of a first type, e.g. inductive boost converter circuitry, while the second instance of supply generator circuitry 112-2 may comprise power converter of a second type, e.g. charge pump circuitry, etc.

The interface circuitry 120 is configured to receive one or more control signals from the external components or subsystems that are coupled to the PMIC 100, via one or more input/output connections (e.g. pins, pads, balls or the like) 122 of the PMIC 100. The control signals may each comprise, for example, a feedback signal and/or a feedforward signal from an external component or subsystem coupled to the PMIC 100. The interface circuitry 120 may also output control signals to the external components or subsystems, via the one or more input/output connections 122.

The controller circuitry 130 is configured to control or adjust operation of the plurality of instances of supply generator circuitry 112-1-112-n based on the control signal(s) received by the interface circuitry 120. The controller circuitry 130 may comprise, for example, a microprocessor, a microcontroller, a state machine, an application specific integrated circuit (ASIC) or discrete circuitry configured to perform control operations for controlling the supply generator circuitry 112-1-112-n.

The controller circuitry 130 may comprise input device detection circuitry 132, signal activity detection circuitry 134 and output device detection circuitry 136. Alternatively, input device detection circuitry 132, signal activity detection circuitry 134 and output device detection circuitry 136 may be provided in the PMIC 100 separately of the controller circuitry 130.

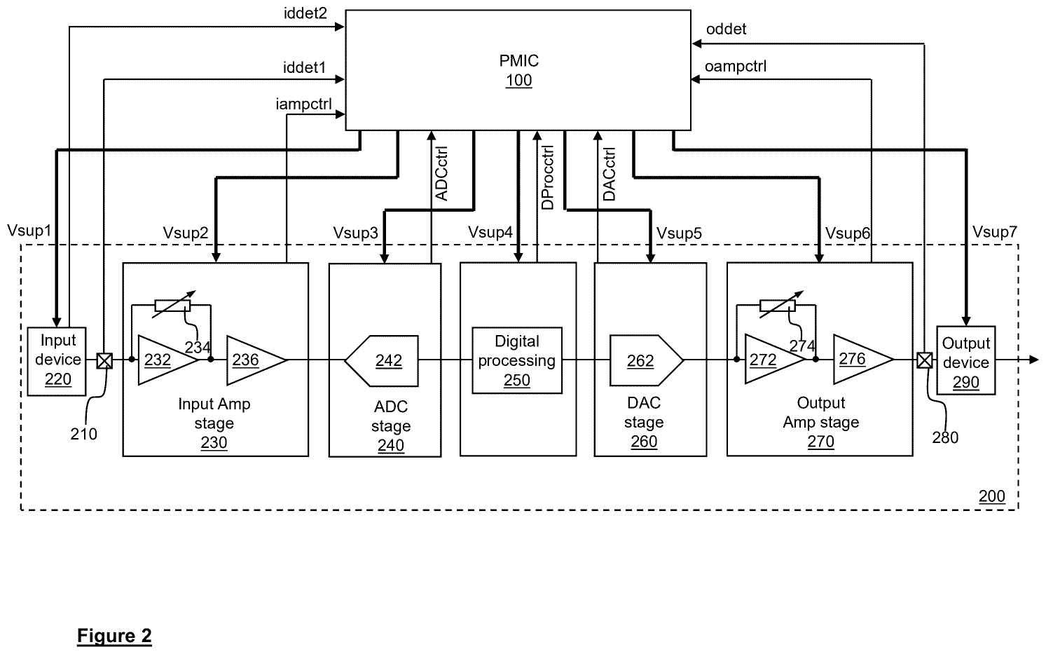

FIG. 2 is a schematic representation of an audio system comprising an audio signal path and the PMIC 100.

The audio signal path, shown generally at 200 in FIG. 2, is configured to receive an input audio signal from an audio input device and process the input audio signal to generate an output audio signal which may be output to an output device, or may be output to one or more downstream digital or analog processing stages for further processing.

The audio signal path 200 includes, in this example, an input device connector 210 to which an input device 220 may be coupled, in use of the audio signal path 200. Where the audio signal path 200 is implemented in one or more ICs, the input device connector 210 will be external to the IC(s) but coupled to an input device connector terminal (e.g. a pin, pad, ball or the like) of the or an IC.

The audio signal path 200 further includes a plurality of audio processing stages or components, including an input amplifier stage 230, an analog to digital converter (ADC) stage 240, a digital processing stage 250, a digital to analog converter (DAC) stage 260, an output amplifier stage 270.

The audio signal path 200 further includes an output device connector 280, to which an output device 290 may be coupled, in use of the audio signal path 200. Where the audio signal path 200 is implemented in one or more ICs, the output device connector 280 will be external to the IC but coupled to an output device connector terminal (e.g. a pin, pad, ball or the like) of the or an IC.

The audio signal path 200 may be, for example, an audio signal path of a consumer electronic device such as: a mobile telephone; a tablet, laptop or desktop computer; a personal audio player; a games console or other electronic gaming device. Alternatively, the audio signal path may be, for example, an audio signal path of a professional audio system such as an audio mixing console; a conference audio system; a public address system; an audio system of a theatre or other performance venue; an audio system of a broadcasting or post-production studio, or an audio signal path of or associated with a musical instrument, e.g. an effects chain loop. It will be appreciated that these are just some examples of systems in which the PMIC 100 may find application; those of ordinary skill in the art will readily appreciate that other applications of the PMIC 100 are possible.

The input device connector 210 is configured to permit the input device 220 to be coupled to the audio signal path 200. The input device connector 210 may comprise, for example, a 3.5 mm or 6.35 mm jack socket, an XLR connector, a TRS (tip-ring sleeve) socket or any other connector that permits the input device 220 to be coupled to the audio signal path 200.

The input device 220 may comprise, for example, a microphone such as a phantom-powered microphone (i.e. a microphone that receives a power supply from an external source), a musical instrument, or the like. The PMIC 100 may be operative, in use of the audio signal path 200, to supply an input device supply voltage Vsup1 to the input device 220, e.g. via the input device connector 210. The input device supply voltage Vsup1 may be, for example, 48V, if the input device 220 is a phantom-powered microphone.

The input amplifier stage 230 constitutes a first (input) analog gain stage of the audio signal path 200, and has an input which is coupled, in use of the audio signal path 200, to an output of the input device 220. The input amplifier stage 230 is configured to amplify an analog signal output by the input device 220 to a level suitable for conversion into a digital signal.

The input amplifier stage 230 comprises, in this example, a first amplifier 232 and a second amplifier 236 coupled in series between an input of the input amplifier stage 230 and an output of the input amplifier stage 230. In this example a gain of the first amplifier 232 is variable by means of a variable resistor 234 in a feedback path between an output of the first amplifier 232 and an input of the first amplifier 232, whereas the second amplifier is a fixed-gain amplifier.

The input amplifier stage 230 receives an input amplifier supply voltage Vsup2 from the PMIC 100. The input amplifier supply voltage Vsup2 may comprise, for example, positive and negative supply voltages or rails of equal magnitude and opposite polarity (e.g. +/−Vsup2). The magnitude of the input amplifier supply voltage Vsup2 may be variable, as will be discussed in more detail below. The input amplifier stage 230 may output an input amplifier control signal iampctrl to the PMIC 100, for use by the controller circuitry 130 of the PMIC 100 in controlling one or more of the instances of supply generator circuitry 112-1-112-n, again as will be described in more detail below.

The ADC stage 240 has an input which is coupled to an output of the input amplifier stage 230. The ADC stage 240 in this example comprises ADC circuitry 242 configured to convert an analog input signal received from the input amplifier stage 230 into a digital signal for storage and/or processing by the digital processing stage 250.

The ADC stage 240 receives an ADC stage supply voltage Vsup3 from the PMIC 100. The ADC stage supply voltage Vsup3 may comprise, for example, a positive supply voltage or rail and a ground or other reference voltage supply or rail (e.g. +Vsup3, GND). The ADC stage supply voltage Vsup3 may be variable, as will be discussed in more detail below. The ADC stage 240 may output an ADC control signal ADCctrl to the PMIC 100, for use by the controller circuitry 130 of the PMIC 100 in controlling one or more of the instances of supply generator circuitry 112-1-112-n, again as will be described in more detail below.

The digital processing stage 250 has an input which is coupled to an output of the ADC stage 240. The digital processing stage 250 is configured to perform digital signal processing operations (e.g. filtering, compression, decompression and the like) on a digital signal received from the ADC stage 240. The digital processing stage 250 may comprise a digital signal processor (DSP), for example.

The digital processing stage 250 receives, in this example, a digital processing stage supply voltage Vsup4 from the PMIC 100. The digital processing stage supply voltage Vsup4 may comprise, for example, a positive supply voltage or rail and a ground or other reference voltage or rail. In other examples the digital processing stage supply voltage Vsup4 may be supplied by a power supply external to the PMIC 100. The digital processing stage may output a digital processing stage control signal DProcctrl to the PMIC 100, for use by the controller circuitry 130 of the PMIC 100 in controlling one or more of the instances of supply generator circuitry 112-1-112-n, as will be described in more detail below.

The DAC stage 260 has an input which is coupled to an output of the digital processing stage 250. The DAC stage 260 in this example comprises DAC circuitry 262 configured to convert a digital input signal received from the digital processing stage 250 into an analog output signal.

The DAC stage 260 receives a DAC stage supply voltage Vsup5 from the PMIC 100. The DAC stage supply voltage Vsup5 may comprise, for example, a positive supply voltage or rail and a ground or other reference voltage supply or rail (e.g. +Vsup5, GND). The DAC stage supply voltage Vsup5 may be variable, as will be discussed in more detail below. The DAC stage 260 may output a DAC control signal DACctrl to the PMIC 100, for use by the controller circuitry 130 of the PMIC 100 in controlling one or more of the instances of supply generator circuitry 112-1-112-n, again as will be described in more detail below.

The output amplifier stage 270 constitutes a second (output) analog gain stage of the audio signal path 200, and has an input which is coupled to an output of the DAC stage 260. The output amplifier stage 270 is configured to amplify an analog signal output by the DAC stage 260 to a level suitable for output to the output device 290.

The output amplifier stage 270 comprises, in this example, a first amplifier 272 and a second amplifier 276 coupled in series between an input of the output amplifier stage 270 and an output of the output amplifier stage 270. In this example a gain of the first amplifier 272 is variable by means of a variable resistor 274 in a feedback path between an output of the first amplifier 272 and an input of the first amplifier 272, whereas the second amplifier is a fixed-gain amplifier.

The output amplifier stage 270 receives an output amplifier supply voltage Vsup6 from the PMIC 100. The output amplifier stage supply voltage Vsup6 may comprise, for example, positive and negative supply voltages or rails of equal magnitude and opposite polarity (e.g. +/−Vsup6), or may alternatively comprise a positive supply voltage or rail and a ground or other reference voltage supply or rail. The output amplifier supply voltage Vsup6 may be variable, as will be discussed in more detail below. The output amplifier stage 270 may output an output amplifier control signal oampctrl to the PMIC 100, for use by the controller circuitry 130 of the PMIC 100 in controlling one or more of the instances of supply generator circuitry 112-1-112-n, again as will be described in more detail below.

The output device connector 280 is coupled to an output of the output amplifier stage 270, and is configured to permit the output device 290 to be coupled to the audio signal path 200. The output device connector 280 may comprise, for example, a 3.5 mm or 6.35 mm jack socket, an XLR connector, a TRS (tip-ring sleeve) socket or any other connected that permits the output device 290 to be coupled to the audio signal path.

The output device 290 may comprise, for example, a speaker (e.g. an active speaker which may receive an output device power supply Vsup7 from the PMIC 100), headphones or the like.

The audio signal path 200 may be implemented, partially or wholly, in an audio codec (COder-DECoder), e.g. a codec IC that may, in use, be coupled to the PMIC 100.

Alternatively, the PMIC 100 and the audio signal path 200 may be integrated in a single IC, e.g. a combined PMIC and audio codec IC.

In a further alternative implementation, the audio signal path may be implemented in a plurality of ICs, e.g. a first amplifier IC implementing the input amplifier stage 230, an ADC IC implementing the ADC stage 240, a digital processor IC implementing the digital processing stage 250, a DAC IC implementing the DAC stage 260 and a second amplifier IC implementing the output amplifier stage 270.

In operation of the audio system shown in FIG. 2, the PMIC 100 is operative to control operation of the supply generator circuitry 112-1-112-n based on one or more control signals received from the audio signal path 200.

As noted above, each instance of supply generator circuitry 112-1-112-n of the PMIC 100 is operative to generate a supply voltage for a stage of the audio signal path. For example, the second instance of supply generator circuitry 112-2 may be operative to generate the input amplifier supply voltage Vsup2 for the input amplifier stage 230, a third instance of supply generator circuitry may be operative to generate the ADC supply voltage Vsup3 for the ADC stage 240, a fourth instance of supply generator circuitry may be operative to generate the digital processing stage supply voltage Vsup4 for the digital processing stage 250, a fifth instance of supply generator circuitry may be operative to generate the DAC supply voltage Vsup5 for the DAC stage 260, a sixth instance of supply generator circuitry may be operative to generate the output amplifier stage supply voltage Vsup6 for the output amplifier stage 270, and a seventh instance of supply generator circuitry may be operative to generate the output device power supply Vsup7 for the output device 290.

Using a separate instance of supply generator circuitry 112-1-112-n to provide the supply voltage for each stage 230-270 of the audio signal path 200 permits precise power delivery to each stage 230-270, which can help to ensure stable performance while optimising power efficiency in the system comprising the PMIC 100 and the audio signal path 200.

The PMIC 100 may be configured to maintain the various stages 230, 240, 250, 260, 270 of the audio signal path 200 and the output device 290 (if connected) in an inactive or low-power state while no input device 220 is connected to the audio signal path 200, by maintaining the instances of supply generator circuitry 112-1-112n in an inactive or low-power state in which no supply voltage, or a low supply voltage (e.g. sufficient to enable a rapid transition by the stages 230-270 to an active state) is supplied to each of the stages 230-270 by the relevant instance of supply generator circuitry 112-1-112-n.

The PMIC 100 may be operative to detect connection of an input device 220 to the audio signal path 200 based on one or more of a number of different signals output by the audio signal path 200.

In one approach, the input device connector 210 may comprise means for detecting connection of the input device 220 to the input device connector 210, e.g. a contact that closes a switch or otherwise makes an electrical connection on insertion of a plug of the input device 220 into the input device connector 210. The input device connector 210 may be configured to output or otherwise supply a first input device detection signal iddet1, indicative of detection of connection of the input device 220 to the input device connector 210, to the controller circuitry 130 of the PMIC 100, or to the input device detection circuitry 132. In response to receiving the first input device detection signal iddet1 (e.g. via the interface circuitry 120), the controller circuitry 130 (or the input device detection circuitry 132, where provided) may determine that an input device 220 is coupled to the input device connector 210.

As noted above, the PMIC 100 may include input device detection circuitry 132, for detecting when an input device 220 is coupled to the input device connector 210. In another approach, which may be used alone or in combination with any other approach to detecting connection of the input device 220 to the input device connector 210, the input device detection circuitry 132 may be configured to determine an impedance at the input device connector 210, based on a voltage and/or current signal received from the input device connector 210 in response to a predefined pilot signal output by the input device detection circuitry 132. The input device detection circuitry 132 may compare the determined impedance to one or more predefined impedance values to determine if an input device 220 is coupled to the input device connector 210. If the determined impedance is greater than a first predefined impedance value, the input device detection circuitry 132 may determine that no input device 220 is coupled to the input device connector 210. If the determined impedance is equal to (or within some threshold of) a second predefined impedance value (which may be, for example, an expected impedance of an input device 220), the input device detection circuitry 132 may determine that an input device 220 is coupled to the input device connector 210.

The input device detection circuitry 132 may also be configured to detect a fault in an input device 220 that is coupled to the input device connector 210, based on the determined impedance at the input device connector 210. For example, if an input device 220 has previously been detected (either based on the determined impedance at the input device connector 210 or by means of a first input device detection signal iddet1 output by the input device connector 210), and the determined impedance subsequently deviates from an expected impedance value, this may be indicative of a fault in the input device 220. In such an event, the input device detection circuitry 132 may output a fault detection signal to the controller circuitry 130, and the controller circuitry 130 may take appropriate action, e.g. powering down one or more stages of the audio signal path 200 and/or notifying a host device incorporating the PMIC 100 and the audio signal path 200 that a fault has been detected, by outputting an interrupt or other signal to a device controller of the host device etc, raising or asserting a flag, setting a register bit, etc.

In a further approach, which again may be used alone or in combination with combination with any other approach to detecting connection of the input device 220 to the input device connector 210, the input device 220 may be configured to output a second input device detection signal iddet2 to the PMIC 100. The second input device detection signal iddet2 may be an output signal of the input device 220, which can be processed by the controller circuitry 130 or the signal activity detection circuitry 134 (if provided) of the PMIC 100 to detect connection of the input device 220 to the audio signal path 200, e.g. by comparing a level of the second input device detection signal iddet2 to a predefined threshold level.

In another approach, which again may be used alone or in combination with combination with any other approach to detecting connection of the input device 220 to the input device connector 210, the PMIC 100 may be configured to detect when an input device 220 is coupled to the input device connector 210 based on a signal iampctrl received (via the interface circuitry 120) from the input amplifier stage 230. When using this approach, the instance of supply generator circuitry 112-1-112-n that provides the supply voltage Vsup2 for the input amplifier stage 230 should be operated in at least a low-power state in which it outputs a supply voltage Vsup2 of sufficient magnitude (e.g. +/−3V) to the input amplifier stage 230 to enable the input amplifier stage 230 to generate the signal iampctrl. As will be appreciated by those of ordinary skill in the art, the signal iampctrl output by the input amplifier stage 230 is an analog signal provided as a feedback signal to the controller circuitry 130 of the PMIC 100. The signal iampctrl may be a dedicated control signal output by the input amplifier stage 230 to the PMIC 100, or alternatively may be tapped off an audio signal in the input amplifier stage 230 of the audio signal path 200.

In this approach, the PMIC 100 determines that the input device 220 has been coupled to the input device connector 210 based on detection of signal content in the audio signal path 200, such as a signal or electrical noise at a level above a threshold level. To this end, the controller circuitry 130 or the signal activity detection circuitry 134 may compare a level of the analog signal iampctrl received from the input amplifier stage 230 to a predefined threshold, which may be a threshold value stored in a memory (e.g. a one-time programmable memory) of the PMIC 100 or a host device incorporating the PMIC 100 and the audio signal path 200. If the level of the received analog signal iampctrl exceeds the predefined threshold, the controller circuitry 130 or signal activity detection circuitry 134 may output a signal indicative of detection of an input device. The predefined threshold may be relatively low, such that the controller circuitry 130 or the signal activity detection circuitry 134 can detect the presence of the input device 220 based on a level of electrical noise that would be consistent with noise generated by the input device 220. Alternatively, the predefined threshold may be of a level that is sufficiently high that the controller circuitry 130 or signal activity detection circuitry 134 would not produce an output signal in response to electrical noise generated by the input device 220, but would produce an output signal in response to a signal output by the input device 220 in response to ambient or background sound (i.e. sound that is not intentionally directed towards the input device 220), such as speech. In some examples the predefined threshold may be configurable or adjustable, such that the sensitivity of detection can be tailored to different input devices.

In a similar approach, which again may be used alone or in combination with combination with any other approach to detecting connection of the input device 220 to the input device connector 210, the controller circuitry 130 of the PMIC 100 may be configured to detect when an input device 220 is coupled to the input device connector 210 based on a signal ADCctrl received (via the interface circuitry 120) from the ADC stage 240. When using this approach, the instances of supply generator circuitry 112-1-112-n that provide the supply voltages Vsup2 for the input amplifier stage 230 and Vsup3 for the ADC stage 240 should be operated in at least a low-power state in which they output supply voltages Vsup2 and Vsup3 of sufficient magnitude (e.g. +/−3V and +3V/GND) to the input amplifier stage 230 and the ADC stage 240, respectively, to enable the input amplifier stage 230 and the ADC stage 240 to generate the signals iampctrl and ADCctrl. As will be appreciated by those of ordinary skill in the art, the signal ADCctrl output by the ADC stage 240 is a digital signal provided as a feedback signal to the controller circuitry 130 of the PMIC 100. The signal ADCctrl may be a dedicated control signal output by the ADC amplifier stage 240 to the PMIC 100, or alternatively may be tapped off an audio signal in the ADC stage 240 of the audio signal path 200.

In this approach, the PMIC 100 again determines that the input device 220 has been coupled to the input device connector 210 based on detection of a signal or electrical noise at a level above a threshold level. The controller circuitry 130 or the signal activity detection circuitry 134 may compare a level of the digital signal ADCctrl received from the ADC stage 240 to a predefined threshold (which again may be adjustable or configurable to tailor the sensitivity of detection to different input devices). If the level of the received digital signal ADCctrl exceeds the predefined threshold, the controller circuitry 130 or signal activity detection circuitry 134 may output a signal indicative of detection of an input device. Again, the predefined threshold may be relatively low, such that the controller circuitry 130 or the signal activity detection circuitry 134 can detect the presence of the input device 220 based on a level of electrical noise that would be consistent with noise generated by the input device 220. Alternatively, the predefined threshold may be of a level that is sufficiently high that the controller circuitry 130 or signal activity detection circuitry 134 would not produce an output signal in response to electrical noise generated by the input device 220, but would produce an output signal in response to a signal output by the input device 220 in response to ambient or background sound such as speech. In this approach the predefined threshold may again be a threshold value stored in a memory (e.g. a one-time programmable memory) of the PMIC 100 or a host device incorporating the PMIC 100 and the audio signal path 200

In a further alternative approach, which again may be used alone or in combination with combination with any other approach to detecting connection of the input device 220 to the input device connector 210, the PMIC 100 may be configured to receive a control signal from monitoring circuitry coupled to or provided in the audio signal path 200, the control signal being indicative of a status of the audio input connector 210.

The controller circuitry 130 of the PMIC 100 may be configured to output suitable control signals to the supply generation subsystem 110 to cause the instances of supply generator circuitry 112-1-112n to remain in the inactive or low-power state until a connection of an input device 220 to the input device connector 210 has been detected using one or more of the approaches described above.

The controller circuitry 130 of the PMIC 100 may be further configured to output suitable control signals to the supply generation subsystem 110 to cause the instances of supply generator circuitry 112-1-112n to enter a normal mode in which they output the supply voltages Vsup2-Vsup7 to the stages 230-270, such that the stages 230-270 transition to an active state when an input device 220 is coupled to the input device connector 210, in response to detection of connection of an input device 220 to the input device connector 210.

By maintaining the supply generator circuitry 112-1-112n in the inactive or low-power state until a connection of an input device 220 to the input device connector 210 has been detected, power consumption of the audio signal path 200 can be minimised or at least reduced when no input device 220 is coupled to the audio signal path 200.

The controller circuitry 130 of the PMIC may be further configured to indicate to a host device that an input device 220 has been detected and the audio signal path 200 is operational, once the stages 230-270 have transitioned to their active state following detection of connection of an input device 220 to the input device connector 210. For example, the controller circuitry 130 may output an interrupt signal to a controller of the host device, or may raise or assert a flag, or may set a register bit to signal to the host device that an input device 220 has been detected and the audio signal path 200 is operational.

In examples in which the input device 220 receives a supply voltage Vsup1 from the PMIC 100, (e.g. where the input device 220 is a phantom powered microphone), the controller circuitry 130 of the PMIC 100 may be configured to output suitable control signals to the supply generation subsystem 110 to cause the instance of supply generator circuitry 112-1-112n that provides the supply voltage Vsup1 to remain in the inactive or low-power state until a connection of an input device 220 to the input device connector 210 has been detected using one or more of the approaches described above.

The PMIC 100 may be operative to detect connection of an output device 290 to the audio signal path 200 based on one or more of a number of different signals output by the audio signal path 200.

In one approach, the output device connector 280 may comprise means for detecting connection of the output device 290 to the output device connector 280, e.g. a contact that closes a switch or otherwise makes an electrical connection on insertion of a plug of the output device 290 into the output device connector 280. The output device connector 280 may be configured to output an output device detection signal oddet, indicative of detection of connection of the output device 290 to the output device connector 280, to the PMIC 100. In response to receiving output device detection signal oddet (e.g. via the interface circuitry 120), the controller circuitry 130 (or the output device detection circuitry 136, where provided) may determine that an output device 290 is coupled to the output device connector 280.

In another approach, the PMIC 100 may be configured to receive a control signal from monitoring circuitry coupled to or provided in the audio signal path 200, the control signal being indicative of a status of the audio output connector 280.

As noted above, the PMIC 100 may include output device detection circuitry 136, for detecting when an output device 290 is coupled to the output device connector 280. In another approach, which may be used alone or in combination with any other approach to detecting connection of the output device 290 to the output device connector 280, the output device detection circuitry 136 may be configured to determine an impedance at the output device connector 280, based on a voltage and/or current signal received from the output device connector 280 in response to a predefined pilot signal output by the output device detection circuitry 136. The output device detection circuitry 136 may compare the determined impedance to one or more predefined impedance values to determine if an output device 290 is coupled to the output device connector 280. If the determined impedance is greater than a first predefined impedance value, the output device detection circuitry 136 may determine that no output device 290 is coupled to the output device connector 280. If the determined impedance is equal to (or within some threshold of) a second predefined impedance value (which may be, for example, an expected impedance of an output device 290), the output device detection circuitry 136 may determine that an output device 290 is coupled to the output device connector 280.

The output device detection circuitry 136 may also be configured to detect a fault in an output device 290 that is coupled to the output device connector 280, based on the determined impedance at the output device connector 280. For example, if an output device 290 has previously been detected (either based on the determined impedance at the output device connector 280 or by means of an output device detection signal oddet output by the output device connector 280), and the determined impedance subsequently deviates from an expected impedance value, this may be indicative of a fault in the output device 290. In such an event, the output device detection circuitry 136 may output a fault detection signal to the controller circuitry 130, and the controller circuitry 130 may take appropriate action, e.g. powering down one or more stages of the audio signal path 200 and/or notifying a host device incorporating the PMIC 100 and the audio signal path 200 that a fault has been detected, e.g. by outputting an interrupt or other signal to a device controller of the host device etc, raising or asserting a flag, setting a register bit, etc.

In examples in which the output device 290 receives a supply voltage Vsup7 from the PMIC 100, (e.g. where the output device 290 is an active speaker or the like), the controller circuitry 130 of the PMIC 100 may be configured to output suitable control signals to the supply generation subsystem 110 to cause the instance of supply generator circuitry 112-1-112n that provides the supply voltage Vsup7 to remain in an inactive or low-power state until a connection of an output device 290 to the output device connector 280 has been detected using one or more of the approaches described above.

The PMIC 100 may be operative to control a level of the supply voltage provided to one or more individual stages 230-270 of the audio signal path 200, based on one or more signals received from the audio signal path 200.

For example, as noted above, the input amplifier stage 230 may be configured to output an analog signal iampctrl, indicative of a level of an input signal to the audio signal path 200 (or equivalently of a level of a signal output by the input amplifier stage 230) to the controller circuitry 130 of the PMIC 100 (e.g. via the interface circuitry 120). The controller circuitry 130 of the PMIC may be configured to output suitable control signals to the supply generation subsystem 110 in response to the analog signal iampctrl to control the supply voltage(s) output to one or more of the stages 230-270.

For example, the controller circuitry 130 may be configured to compare the analog signal iampctrl (or a digitised version of the analog signal iampctrl, output by ADC circuitry of the PMIC 100) to a first predefined signal level threshold. If the magnitude of the analog signal iampctrl is below the first predefined signal level threshold, this may be indicative that the level of the input signal is small and thus that a relatively low supply voltage may be supplied to the input amplifier stage 230 without causing distortion, clipping or other effects that may adversely affect fidelity of an output signal of the input amplifier stage 230.

Accordingly, if a magnitude of the analog signal iampctrl (or a digital version thereof) is less than the first predefined signal level threshold, the controller circuitry 130 may output a control signal to the supply generation subsystem 110 to cause the supply voltage Vsup2 to the input amplifier stage 230 to be set to a first, relatively low level, e.g. +/−5V. The controller circuitry 130 may output a further control signal to the supply generation subsystem 110 to cause the supply voltage Vsup6 to the output amplifier stage 270 to be set to a first, relatively low level, e.g. +/−5V. The controller circuitry 130 may output further control signals to the supply generation subsystem 110 to set the supply voltage Vsup1 to the input device 220 to a first, relatively low level, and to set the supply voltage Vsup7 to the output device 290 to a first, relatively low level. Because the level of the output signal of the input amplifier stage 230 will be relatively low in such circumstances, the controller circuitry 130 may also, in some examples, output suitable control signals to the supply generation subsystem 110 to cause the supply voltage Vsup3 to the ADC stage 240 to be set to a first, relatively low level, e.g. +3.3V/GND, the supply voltage Vsup5 to the DAC stage to be set to a first, relatively low level, e.g. +3.3V/GND. In other examples, the supply voltages Vsup3 and Vsup5 are maintained at a second, relatively high level, e.g. +5V/GND if any analog signal iampctrl is present, but may be reduced to zero if no analog signal iampctrl is present

In contrast, if the magnitude of the analog signal iampctrl (or a digital version thereof) is equal to or greater than the first predefined signal level threshold, this may be indicative that the level of the input signal is large and thus that a relatively high supply voltage should be supplied to the input amplifier stage 230 to avoid distortion, clipping or other effects that may adversely affect fidelity of the output signal of the amplifier stage 230.

Accordingly, if the magnitude of the first signal iampctrl (or a digital version thereof) is equal to or greater than the first predefined signal level threshold, the controller circuitry 130 may output a control signal to the supply generation subsystem 110 to cause the supply voltage Vsup2 to the input amplifier stage 230 to be set to a second, relatively high level, e.g. +/−15V or +/−18V. The controller circuitry 130 may output a further control signal to the supply generation subsystem 110 to cause the supply voltage Vsup6 to the output amplifier stage 270 to be set to a second, relatively high level, e.g. +/−15V or +/−18V. The controller circuitry 130 may output further control signals to the supply generation subsystem 110 to set the supply voltage Vsup1 to the input device 220 to a second, relatively high level, and to set the supply voltage Vsup7 to the output device 290 to a second, relatively low level. Because the level of the signal output by the input amplifier stage 230 will be relatively high in these circumstances, the controller circuitry 130 may also, in some examples, output suitable control signals to the supply generation subsystem 110 to cause the supply voltage Vsup3 to the ADC stage 240 to be set to a second, relatively high level, e.g. +5V/GND, the supply voltage Vsup5 to the DAC stage to be set to a second, relatively high level, e.g. +5V/GND, and the supply voltage Vsup6 to the output amplifier stage to be set to a second, relatively high level, e.g. +/−15V or +/−18V.

In some examples, the controller circuitry 130 may be configured to cause the supply voltage Vsup2 to the input amplifier stage 230 to be modulated according to a detected level of a signal in the audio signal path 200, e.g. the input signal to the audio signal path 200, as indicated, for example, by the first signal iampctrl. Thus, as the level of the signal in the audio signal path 200 increases, the supply voltage Vsup2 to the input amplifier stage 230 also increases, and as the level of the signal in the audio signal path 200 decreases, the supply voltage Vsup2 to the input amplifier stage 230 also decreases.

In such examples, the controller circuitry 130 may select a level or magnitude of the supply voltage Vsup2 from a plurality of discrete supply voltage Vsup2 levels to increase and decrease the supply voltage Vsup2 in discrete steps, such that the input amplifier stage 230 operates in a manner similar to a Class G amplifier.

Alternatively, the controller circuitry 130 may cause the supply voltage Vsup2 to the input amplifier stage 230 to vary continuously (over a predefined supply voltage range) based on the signal level, such that the input amplifier stage 230 operates in a manner similar to a Class H amplifier.

Controlling the supply voltage Vsup2 to the input amplifier stage 230 based on a signal level in the audio signal path 200 such as the input signal level in this manner helps to reduce the power consumption of the audio signal path 200, as the supply voltage Vsup2 can be reduced when a higher supply voltage is not required.

In particular, dynamically scaling the supply voltage Vsup2 to the input amplifier stage 230 such that the supply voltage Vsup2 is continuously variable based on the signal level may help to maintain an optimal balance between performance (e.g. in terms of audio fidelity in the audio signal path 200) and power consumption.

Additionally or alternatively, the PMIC 100 may be operative to control one or more of the supply voltages Vsup2, Vsup3, Vsup5, Vsup6 based on the digital signal ADCctrl output by the ADC stage 240, which is indicative of a level of the signal output by the input amplifier stage 230. In such examples, the controller circuitry 130 of the PMIC 100 may be operative to compare the digital signal ADCctrl to a predefined reference signal, and to control one or more of the supply voltages Vsup2, Vsup3, Vsu5, Vsup6 based on the result of the comparison.

Thus, if the digital signal ADCctrl is less than the predefined reference signal, the controller circuitry 130 may output suitable control signals to the supply generation subsystem 110 to cause the supply voltage Vsup2, and optionally also the supply voltages Vsup3, Vsup5, Vsup6 to be set to their first, relatively low levels, as described above, whereas if the digital signal ADCctrl is greater than the predefined reference signal, the controller circuitry 130 may output suitable control signals to the supply generation subsystem 110 to cause the supply voltage Vsup2, the supply voltages Vsup6, and, in some examples, the supply voltages Vsup3, Vsup5 to be set to their second, relatively high levels, as described above.

Additionally or alternatively, the controller circuitry 130 may be operative to control one or more of the supply voltages Vsup2, Vsup3, Vsup5, Vsup6 based on the digital signal DACctrl output by the DAC stage 260 (e.g. based on a comparison of the digital signal DACctrl to a predefined threshold, in a similar manner as described above in relation to the digital signal ADCctrl output by the ADC stage 240), and/or based on the analog signal oampctrl output by the output amplifier stage 270 (e.g. based on a comparison of the analog signal oampctrl to a predefined threshold, in a similar manner as described above in relation to the analog signal iampctrl output by the input amplifier stage 230).

The signal DACctrl output by the DAC stage 260 is a digital signal provided as a feedback signal to the controller circuitry 130 of the PMIC 100. The signal DACctrl may be a dedicated control signal output by the DAC stage 260 to the PMIC 100, or alternatively may be tapped off an audio signal in the DAC stage 260 of the audio signal path 200.

The signal oampctrl output by the output amplifier stage 270 is an analog signal provided as a feedback signal to the controller circuitry 130 of the PMIC 100. The signal oampctrl may be a dedicated control signal output by the output amplifier stage 270 to the PMIC 100, or alternatively may be tapped off an audio signal in the output amplifier stage 270 of the audio signal path 200.

The PMIC 100 may be operative to maintain a level of the supply voltages provided to all the individual stages 230-270 at a maximum level when high fidelity operation of the audio signal path 200 is required. For example, in response to receiving a signal (e.g. from a controller of a host device incorporating the PMIC 100 and the audio signal path 200), the PMIC may 100 output a suitable control signal to the supply generation subsystem 110 to cause each instance (or each relevant instance) 112-1-112-n of supply generator circuitry to output a maximum supply voltage Vsup2-Vsup6 to its associated stage 230-270 of the audio signal path 200.

Maintaining the supply voltages Vsup2-Vsup6 at their maximum levels in this way ensures that maximum audio fidelity is available when required.

The PMIC 100 may, additionally or alternatively, be configured to control the level of the supply voltage provided to one or more individual stages 230-270 of the audio signal path 200 based on a control signal received from monitoring circuitry coupled to or provided in the audio signal path 200, where the control signal is indicative of a status of the audio input connector 210.

The PMIC 100 may be further operative to control a supply voltage to an individual component or subsystem of a stage 230-270 of the audio signal path 200, based on a control signal output by the audio signal path 200.

For example, the PMIC 100 may be operative to control a supply voltage to an individual component or subsystem (e.g. an individual gain element) of a stage 230-270 of the audio signal path 200 based on a control signal, output by one of the stages 230-270, indicative of a level of an input signal to the audio signal path 200 or indicative of a level of an output signal of the audio signal path 200.

Thus, the PMIC 100 may be operative, for example, to control a supply voltage to the first amplifier 232 and/or the second amplifier 236 of the input amplifier stage 230 based on a control signal output by the input amplifier stage 230 (e.g. the analog signal iampctrl) and/or a control signal output by the ADC stage 240 (e.g. the digital signal ADCctrl) indicative of a level of an input signal to the audio signal path 200 or based on a control signal output by the output amplifier stage 270 (e.g. the analog signal oampctrl) and/or a control signal output by the DAC stage 260 (e.g. the digital signal DACctrl) indicative of a level of an output signal of the audio signal path 200.

Similarly, the PMIC 100 may be operative, for example, to control a supply voltage to the first amplifier 272 and/or the second amplifier 276 of the output amplifier stage 270 based on a control signal output by the input amplifier stage 230 (e.g. the analog signal iampctrl) and/or a control signal output by the ADC stage 240 (e.g. the digital signal ADCctrl) indicative of a level of an input signal to the audio signal path 200, or based on a control signal output by the output amplifier stage 270 (e.g. the analog signal oampctrl) and/or a control signal output by the DAC stage 260 (e.g. the digital signal DACctrl) indicative of a level of an output signal of the audio signal path 200.

Additionally or alternatively, the PMIC 100 may be operative, for example, to control a supply voltage to a gain element of the ADC stage 240 or the DAC stage 260 based on a control signal output by the input amplifier stage 230 (e.g. the analog signal iampctrl) and/or a control signal output by the ADC stage 240 (e.g. the digital signal ADCctrl) indicative of a level of an input signal to the audio signal path 200, or based on a control signal output by the output amplifier stage 270 (e.g. the analog signal oampctrl) and/or a control signal output by the DAC stage 260 (e.g. the digital signal DACctrl) indicative of a level of an output signal of the audio signal path 200.

Additionally or alternatively, the PMIC 100 may be operative to control operation of an LDO of the input amplifier stage 230 and/or to control operation of an LDO of the output amplifier stage 270 based on a control signal, output by one of the stages 230-270, indicative of a level of an input signal to the audio signal path 200 or indicative of a level of an output signal of the audio signal path 200.

The PMIC 100 may be further configured to control or adjust its own operation based on signals received from the audio signal path 200.

For example, the PMIC 100 may be operative to control a switching frequency of one or more of the instances of supply generator circuitry 112-1-112-n based on a supply voltage Vsup2-Vsup6 being output to a stage 230-270 of the audio signal path 200, or based on a level of an input signal to the audio signal path 200, or based on a level of an output signal of the audio signal path 200.

In one example, the PMIC 100 may be operative to adjust a switching frequency of one or more of the instances of supply generator circuitry 112-1-112-n based on the level of the input signal (as indicated, for example, by a signal iampctrl received from the input amplifier stage 230, and/or by a signal ADCctrl received from the ADC stage 240) or the level of the output signal (as indicative, for example, by a signal DACctrl received from the DAC stage 260 and/or by a signal oampctrl received from the output amplifier stage 270).

In some examples, if the input signal level is below an input signal level switching frequency threshold and/or if the output signal level is below an output signal level switch frequency threshold, the PMIC 100 may output suitable control signals to the supply voltage generation subsystem 110 to reduce the switching frequency of the one or more instances of supply generator circuitry 112-1-112-n from a relatively high switching frequency that is outside the audio signal band (e.g. above 20 kHz) to a lower switching frequency that is within the audio signal band (e.g. below 20 kHz).

At lower input and/or output signal levels, high audio fidelity may be less important than low power consumption. Reducing the switching frequency of the one or more of the instances of supply generator circuitry 112-1-112-n in this way may thus reduce the power consumption of the PMIC 100, but may increase switching noise in the audio signal band. This may be an acceptable trade off in some circumstances, e.g. when the stages 230-270 of the audio signal path 200 are in active or operating in a low-power state while no input device 220 has been detected.

If the input signal level is greater than the input signal level switching frequency threshold and/or if the output signal level is greater than the output signal level switching frequency threshold, the PMIC 100 may output suitable control signals to the supply voltage generation subsystem 110 to maintain the switching frequency of the one or more instances of supply generator circuitry 112-1-112-n at the relatively high switching frequency or to increase the switching frequency of the one or more instances of supply generator circuitry 112-1-112-n to the relatively high switching frequency.

In another example, the PMIC 100 may be operative to adjust a switching frequency of one or more of the instances of supply generator circuitry 112-1-112-n based on the output voltage being supplied by that instance of supply generator circuitry 112-1-112-n.

For example, if an instance of supply generator circuitry 112-1-112-n is supplying an output voltage that is lower than a predefined output voltage threshold, e.g. because the stage 230-270 being supplied by that instance of supply generator circuitry 112-1-112-n is in a low power or inactive state, the PMIC 100 may output a suitable control signal to the supply voltage generation subsystem 110 to reduce the switching frequency of that instance of supply generator circuitry 112-1-112-n from the relatively high switching frequency to the lower switching frequency.

If the instance of supply generator circuitry 112-1-112-n is supplying an output voltage that is greater than the predefined output voltage threshold, e.g. because the stage 230-270 being supplied by that instance of supply generator circuitry 112-1-112-n is in a full power or active state, the PMIC 100 may output a suitable control signal to the supply voltage generation subsystem 110 to maintain the switching frequency of that instance of supply generator circuitry 112-1-112-n at the relatively high switching frequency or to increase the switching frequency of that instance of supply generator circuitry 112-1-112-n to the relatively high switching frequency, as appropriate.

Additionally or alternatively, where an instance of supply generator circuitry 112-1-112-n comprises LDO regulator circuitry, the PMIC 100 may be operative to control operation of such LDO regulator circuitry based on a state of a stage 230-270 of the audio signal path 200 that receives a power supply from that instance of supply generator circuitry 112-1-112-n, e.g. by outputting (by the controller circuitry 130) suitable control signals to the supply voltage generation subsystem 110 to cause the LDO circuitry to enter a low-power, bypass or standby mode of operation, as required.

For example, if the LDO regulator circuitry is operative to provide a supply voltage to a stage 230-270 of the audio signal path 200 that has entered an inactive state, the controller circuitry 130 may output a suitable control signal to the supply voltage generation subsystem 110 to cause the LDO of the relevant instance of supply generator circuitry 112-1-112-n to enter a standby mode of operation. Similarly, if the stage 230-270 has entered a low-power state, the controller circuitry 130 may output a suitable control signal to the supply generator circuitry 110 to cause the LDO of the relevant instance of supply generator circuitry 112-1-112-n to enter a low-power mode of operation.

In the example illustrated in FIG. 2, the PMIC 100 controls operation of a single audio signal path 200. However, a single PMIC 100 may be configured to control operation of a plurality of audio signal paths of the kind shown at 200 in FIG. 2. For example, in a mixing console, public address (PA) system or the like, a single PMIC 100 may be coupled to eight (or more) audio signal paths, each of which provides one channel of a multi-channel audio system.

In such arrangements, the PMIC 100 can set an entire channel to an inactive or low-power state when no input device or output device is detected for that channel using one or more of the approaches described above. The PMIC 100 may maintain other channels in a maximum power state, and may control the supply voltage to individual stages or individual components or subsystems of stages of other channels, based on control signals received from those channels, e.g. control signals indicative of an input signal level and/or an output signal level of a channel, as described above.

Such granularity can be advantageous in mixing consoles, recording studios and playback system such as theatre- or arena-scale active speaker systems, where multiple audio channels operate independently and may not always require full power simultaneously.

This functionality is also particularly valuable in live audio setups, where numerous microphones and/or instruments may be connected and disconnected frequently.

Mixing desks in recording studios and live concert environments often process dozens or even hundreds of channels simultaneously. In such applications, the PMIC 100 of the present disclosure can optimise power distribution per channel based on actual (e.g. real-time) input signal levels, reducing thermal dissipation, improving longevity of the mixing desk and reducing cooling and/or energy costs. Additionally, the PMIC 100 of the present disclosure allows selective deactivation of idle channels, saving energy during recording or live performances.

In theatres and other venues, large-scale PA systems typically handle multiple microphone and/or instrument feeds. When deployed in such PA systems, the PMIC 100 of the present disclosure can adjust power to such feeds dynamically, based on real-time audio activity, ensuring power-efficient operation when certain microphone or instrument feeds are not in use, and reducing energy consumption (and thus cost) in such venues.

For conference halls and corporate PA systems, the PMIC 100 of the present disclosure can minimise standby power consumption when no speech or other input is detected, and can dynamically allocate power based on active speakers or microphones.

For musical instruments and/or effects systems (e.g. effects units, chains or loops) that can be battery operated, the PMIC 100 of the present disclosure can increase the duration for which the instrument or effects system can be operated from the battery, which may reduce the cost of replacing or recharging batteries, over the long term.

A PMIC 100 and audio system (comprising the PMIC 100 and an audio signal path 200) provides a power-efficient approach to audio signal processing. By dynamically adjusting supply rail levels (i.e. the magnitude of supply voltages) for stages of the audio signal path 200, the PMIC 100 reduces power consumption of the system while maintaining high-fidelity audio performance.

FIG. 2 shows a single PMIC 100 coupled to both input and output stages of an audio signal path 200. However, in some applications it may be beneficial to have a first PMIC for input stages of an audio signal path and a second PMIC 100 for output stages of an audio signal path.

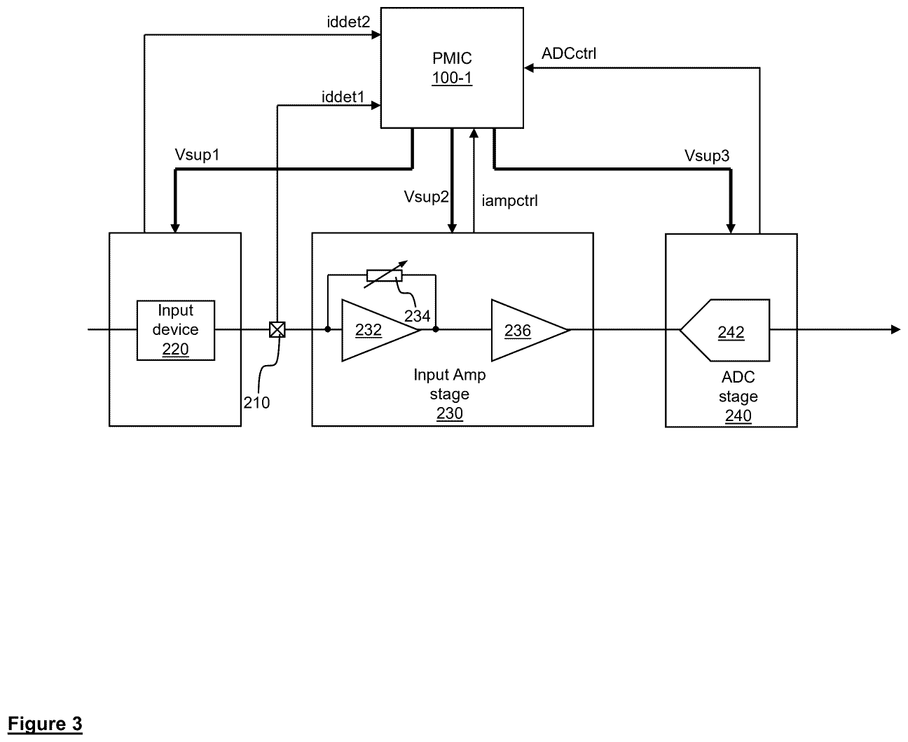

FIG. 3 is a schematic representation of a PMIC 100-1 coupled to input stages of the audio signal path 200 of FIG. 2. Thus, in the example shown in FIG. 3, the PMIC 100-1 (which is a PMIC of the kind described above with reference to FIG. 1) outputs supply voltages Vsup2 and Vsup3 to the input amplifier stage 230 and the ADC stage 240, respectively, of the audio signal path 200, and may also output a supply voltage Vsup1 to an input device 220 such as a phantom-powered microphone. The PMIC 100-1 is configured to detect the presence of an input device 220 coupled to the input device connector 210, and to control the supply voltages supplied by the PMIC 100-1 to the input amplifier stage 230 and the ADC stage 240 and to individual components or subsystems of those stages, as described above with reference to FIG. 2. The PMIC 100-1 is also configured to control its own operation, as described above with reference to FIG. 2.

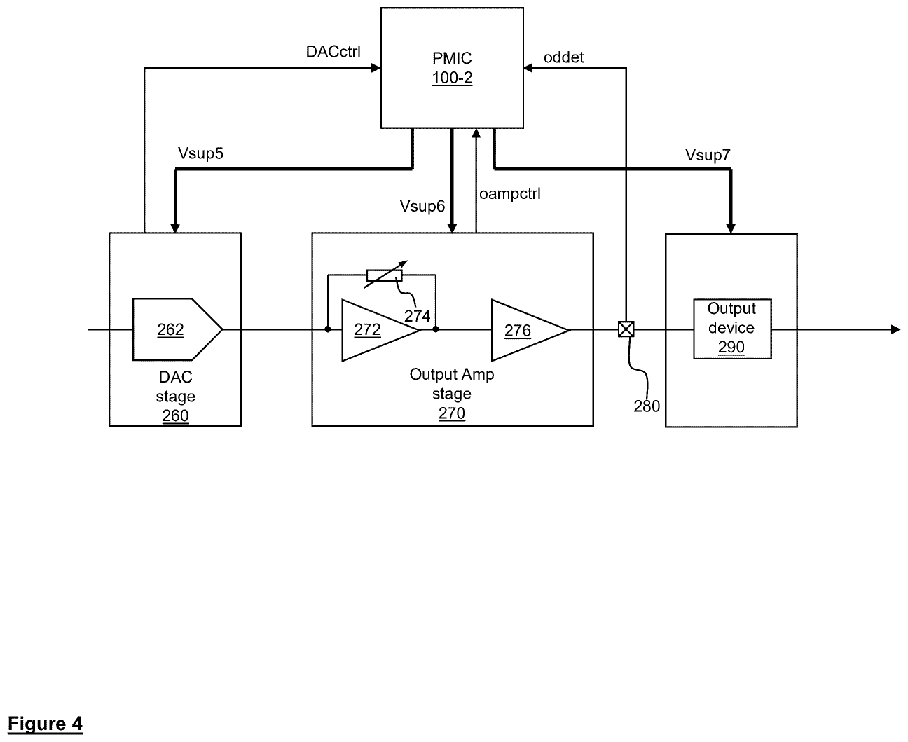

FIG. 4 is a is a schematic representation of a PMIC 100-2 coupled to output stages of the audio signal path 200 of FIG. 2. Thus, in the example shown in FIG. 4, the PMIC 100-2 (which is a PMIC of the kind described above with reference to FIG. 1) outputs supply voltages Vsup5 and Vsup6 to the DAC stage 260 and the output amplifier stage 270, respectively, of the audio signal path 200, and may also output a supply voltage Vsup7 to an output device 290 such as an active speaker. The PMIC 100-2 is configured to detect the presence of an output device 290 coupled to the output device connector 280, and to control the supply voltages supplied by the PMIC 100-2 to the DAC stage 260 and the output amplifier stage 270 to individual components or subsystems of those stages, as described above with reference to FIG. 2. The PMIC 100-2 is also configured to control its own operation, as described above with reference to FIG. 2.

The PMIC 100 is shown in FIG. 2 and described above as being coupled to an audio signal path 200. However, as will be apparent to those of ordinary skill in the art, the PMIC 100 is not limited to audio applications and is equally suitable for use with other multi-stage signal paths.

For example, the PMIC 100 could be used in an image or video processing signal to provide and control supply voltages for stages of a multi-stage signal path configured to preform processing operations on an image or video signal.

As another example, the PMIC 100 could be used in a sensing system to provide and control supply voltages for stages of a multi-stage signal path configured to perform processing operations on a signal output by a sensor such as, for example, a temperature sensor, a strain gauge, a radar or lidar sensor, a biomedical sensor or the like. In a multi-sensor system, a single PMIC 100 could be used to provide and control supply voltages for stages of multiple different sensor signal paths, each of which comprises a plurality of stages for processing a signal output by a different sensor, or multiple PMICs 100 could be used, each providing and controlling supply voltages for one or more individual sensor signal paths.

As another example, the PMIC 100 could be used in a transmitter and/or a receiver of a communications system such as a Wi-Fi, Lif-Fi, Bluetooth, cellular or satellite communication system, to provide and control supply voltages for stages in one or more multi-stage signal processing paths.

The PMIC and/or other circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device, an audio mixing console, a public address (PA) system, an audio system of a performance venue, an audio system of a broadcasting or post-production studio, or another professional audio system.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

Aspects of the present disclosure are described in the following paragraphs.

There is provided a power management integrated circuit (or PMIC) for an audio signal path of an audio system, wherein the PMIC comprises supply generation circuitry configured to generate one or more power rails for components of the audio signal path, and wherein the PMIC is configured to adjust a level of the one or more power rails based on a signal level of an audio signal in the audio signal path.

The PMIC may disable or make inactive one or more power rails based on the signal level.

In one implementation, the PMIC is configured to receive a Signal Activity Detection signal from a component of the audio signal path, and wherein the PMIC adjusts a level of the one or more power rails based on the received Signal Activity Detection signal.

Additionally or alternatively, the PMIC is configured to monitor signal content of the audio signal path, wherein the PMIC performs Signal Activity Detection on the monitored signal content, and wherein the PMIC adjusts a level of the one or more power rails based on the monitored status of the audio connector.

The audio signal path may be configured with a branch connection wherein a portion of the audio signal is tapped off from the main path, such that the PMIC itself can perform signal activity detection. The PMIC may monitor an analog signal level, e.g. as an audio signal passes through analog circuitry of the audio signal path, and/or the PMIC may monitor a digital signal, e.g. as an audio signal passes through digital circuitry of the audio signal path. For the monitoring of an analog audio signal, the PMIC may comprise an analog-to-digital converter (or ADC) to convert the monitored signal to a digital value which can then be compared with a threshold or analysed to determine signal activity in the analog audio signal, or the PMIC may comprise a comparator or similar circuitry wherein the monitored signal can be compared to a threshold voltage level to generate a signal activity flag within the PMIC itself.

Additionally or alternatively, the PMIC is configured to monitor the status of an audio connector of the audio signal path for the connection of an audio peripheral with the audio signal path, e.g. a microphone, an audio headset, an external loudspeaker, wherein the PMIC adjusts a level of the one or more power rails based on the monitored status of the audio connector.

There is also provided an audio system having at least one audio signal path comprising: One or more audio components provided as part of the at least one audio signal path, the components arranged to receive an input audio signal and generate an output audio signal; a power management integrated circuit (or PMIC) as described above, wherein the PMIC generates one or more separate power rails for the one or more audio components of the audio signal path, wherein the PMIC is configured to receive a signal indicative of a signal level of an audio signal in the audio signal path and/or to perform signal activity detection on an audio signal present in the audio signal path, and wherein the PMIC is configured to adjust the level of at least one power rail generated by the PMIC based on the received signal or the detected activity level of the audio signal.

In a preferred implementation, there is provided a power management IC (or PMIC) for an audio signal path of an audio system, where the audio signal path comprises at least a first analog gain stage and a second analog-to-digital conversion stage, the PMIC comprising supply generation circuitry configured to: generate a first power rail for the first analog gain stage of the audio signal path, and generate a second power rail for the second analog-to-digital conversion stage of the audio signal path, wherein the PMIC the PMIC adjusts the level of one or more of the first or second power rails based on the signal level of the audio signal path.

The PMIC may generate a power rail for microphone power generation for a microphone of an audio signal path.

Preferably, the PMIC receives a control signal from the audio signal path, wherein the PMIC adjusts the level of the power rail based on the received control signal.

The first and second power rails are preferably generated at a level to allow for normal operation of the first and second stages of the analog signal path.

In one aspect, the control signal comprises a feedback signal from the second analog-to-digital conversion stage of the audio signal path, preferably a digital feedback signal, wherein the feedback signal provides an indication of the signal level of an audio signal detected in the audio signal path.

Preferably, the PMIC is configured to reduce the level of the first power rail and/or the second power rail based on an indication that the signal level of the audio signal is at a relatively low level.

In one aspect, the PMIC is configured to compare the signal level of the audio signal to a threshold level, wherein the PMIC reduces the level of the first power rail and/or the second power rail when the signal level is below the threshold level.

Additionally or alternatively, the PMIC is configured to dynamically adjust the level of the first power rail and/or the second power rail in proportion to the signal level of the audio signal.

In a further aspect, the PMIC is configured to generate separate power rails or control signals for components of the first analog gain stage of the audio signal path, wherein the PMIC is configured to adjust the separate power rails or control signals based on the received control signal.

For example, the PMIC may act to reduce the power level supplied to individual components of the first stage, and/or to control individual components of the stage, such as LDO regulators, to deactivate or be placed in a low-power or standby mode.

In a further aspect, the control signal comprises a signal from monitoring circuitry provided in the audio signal path, the monitoring circuitry configured to monitor the status of an audio connector provided as part of the audio signal path, wherein the PMIC is configured to adjust the level of one or more of the first or second power rails based on the monitored status of the audio connector. Preferably, the PMIC is configured to maintain the first and/or second stage of the audio signal path in a low-power or inactive stage until connection of a peripheral to the audio connector is detected.

Further details of such a control scheme may be found in U.S. Provisional Patent Application No. 63/676,475, the contents of which may be incorporated by reference herein.

In an additional or alternative aspect, there is provided a PMIC for an audio signal path of an audio system, where the audio signal path comprises at least a digital-to-analog conversion stage and an output analog gain stage, wherein the PMIC comprises supply generation circuitry configured to: generate a third power rail for the digital-to-analog conversion stage, and generate a fourth power rail for the output analog gain stage, wherein the PMIC receives a digital control signal from the audio signal path, such that the PMIC adjusts the level of one or more of the third or fourth power rails based on the received digital control signal.

It will be understood that the PMIC may be configured to adjust the levels of the third and fourth power rails based on the digital control signal, similar to the control of the first and second power rails as described above.

In a further aspect, it will be understood that the PMIC may be configured to generate separate first and second power rails for a plurality of audio signal paths, wherein the levels of the individual first and second power rails for the different audio signal paths may be separately adjusted based on separate control signals received in respect of the different audio signal paths.

There is further provided a converter integrated circuit (or IC), wherein the converter IC comprises at least one analog-to-digital converter for an audio signal path of an audio system, wherein the converter IC is configured to generate a control signal to be output from the converter IC, wherein the control signal comprises an indication of a signal level of an audio signal converted by the analog-to-digital converter.

There is further provided an audio system having at least one audio signal path comprising: a first analog gain stage to receive an input audio signal and output an amplified audio signal; a converter integrated circuit coupled to the first analog gain stage, the converter integrated circuit comprising an analog-to-digital converter to convert the amplified audio signal to a digital audio signal, and a power management IC (or PMIC) as described above, wherein the PMIC generates separate power rails for the first and second stages of the audio signal path, wherein the converter integrated circuit is configured to output a control signal comprising an indication of the signal level of the audio signal of the audio signal path, and wherein the PMIC is configured to receive the control signal, and to adjust the level of at least one power rail generated by the PMIC based on the received control signal.

There is provided a power management integrated circuit (PMIC) for use in an audio system, the PMIC comprising: supply generation circuitry configured to generate voltage supplies for system components; and monitoring circuitry configured to monitor the status of an audio connector of the system; wherein the PMIC is arranged to maintain the supply generation circuitry in a low-power or inactive state until connection of a peripheral to the audio connector is detected.

Preferably, the audio connector is selected from the group consisting of 3.5 mm audio jacks, XLR connectors, and TRS connectors.

Preferably, the audio peripheral is selected from the group consisting of a speaker and a microphone.

In some implementations, the microphone is a phantom-powered microphone.

Preferably, the monitoring circuitry comprises a detection mechanism for detecting electrical characteristics indicative of a peripheral connection.

Preferably, the detection mechanism includes impedance measurement circuitry.

Preferably, the supply generation circuitry includes voltage regulators that are deactivated in the absence of a detected peripheral connection.

Preferably, the monitoring circuitry detects the connection of a peripheral using impedance measurement, voltage level detection, current sensing, mechanical switches, or digital communication.

Preferably, the PMIC further comprises control logic configured to transition the supply generation circuitry from the low-power state to an active state upon detection of a peripheral connection.

Preferably, the control logic reverts the supply generation circuitry to the low-power state upon disconnection of the peripheral.

Preferably, the supply generation circuitry provides supply rails for components selected from the group consisting of ADCs, DACs, operational amplifiers, microphone pre-amplifiers, and phantom-powered microphones.

Preferably, the PMIC further comprises an interrupt mechanism configured to send an interrupt request (IRQ) or signal to a coupled processor of the system indicating that a channel is live and functioning upon detection of a connected peripheral.

Preferably, the monitoring circuitry comprises a Signal Activity Detector arranged to monitor the level of a signal at an audio connector of the system. The signal level may be compared with a defined threshold level of signal to determine if a peripheral has been connected to the audio connector

There is also provided an audio mixing desk comprising: a connector for connecting an audio peripheral; a power management integrated circuit (PMIC) according to any of the preceding paragraphs, configured to supply power to system components of the audio mixing desk based on the connection status of the audio peripheral.

Preferably, the PMIC controls the power supply for an individual channel of the audio mixing desk based on the connection status of an audio peripheral to the audio connector associated with that channel.

As used herein, when two or more elements are referred to as “coupled” to one another, such term indicates that such two or more elements are in electrical, mechanical, or electromechanical communication, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A power management integrated circuit (PMIC) for a system that comprises a signal path having a plurality of stages, the PMIC comprising:
supply generation circuitry for generating supply voltages for the stages of the signal path; and
controller circuitry configured to control operation of the supply generation circuitry based on a signal received from the signal path.

2. The PMIC of claim 1, wherein the supply generation circuitry comprises a plurality of instances of supply generator circuitry, each instance of supply generator circuitry configured to generate a respective output voltage for use as a supply voltage to a stage of the signal path.

3. The PMIC of claim 2, wherein the controller circuitry is configured to control the output voltage of an instance of supply generator circuitry based on the signal received from the signal path.

4. The PMIC of claim 1, wherein the signal received from the signal path is indicative of a level of an input signal to the signal path.

5. The PMIC of claim 4, wherein the controller circuitry is operative to control a supply voltage to an amplifier stage of the signal path based on the signal received from the signal path.

6. The PMIC of claim 5, wherein the controller circuitry is operative to select a level of the supply voltage from a plurality of discrete supply voltage levels based on the signal received from the signal path.

7. The PMIC of claim 5, wherein the controller circuitry is operative to modulate a level of the supply voltage over a supply voltage range based on the signal received from the signal path.

8. The PMIC of claim 4, wherein the controller circuitry is operative to control a supply voltage to an analog to digital converter (ADC) stage of the signal path based on the signal received from the signal path.

9. The PMIC of claim 4, wherein the controller circuitry is operative to control a supply voltage to a digital to analog converter (DAC) stage of the signal path based on the signal received from the signal path.

10. The PMIC of claim 4, wherein the controller circuitry is operative to control a supply voltage to a component or subsystem of a stage of the signal path based on the signal received from the signal path.

11. The PMIC of claim 2, wherein the PMIC is configured to control one or more of:
a switching frequency of one of the plurality of instances of supply generator circuitry; and
a mode of operation of low dropout regulator circuitry of one of the plurality of instances of supply generator circuitry,
based on the signal received from the signal path or based on an output voltage of the one of the plurality of instances of supply generator circuitry.

12. The PMIC of claim 1, wherein the signal received from the signal path is indicative of connection of an input device or an output device to the signal path.

13. The PMIC of claim 12, wherein the PMIC is configured to maintain the stages of the signal path in an inactive or low-power state while no input device is connected to the signal path.

14. The PMIC of claim 12, wherein the signal received from the signal path is indicative of an impedance at an input device connector or an output device connector coupled to the signal path.

15. The PMIC of claim 14, wherein the controller circuitry is operative to compare the impedance at the input device connector to a reference impedance to detect that an input device is coupled to the signal path and/or to detect a fault in an input device coupled to the signal path.

16. The PMIC of claim 12, wherein the controller circuitry is operative to compare the impedance at the output device connector to a reference impedance to detect that an output device is coupled to the signal path and/or to detect a fault in an output device coupled to the signal path.

17. The PMIC of claim 12, wherein the PMIC comprises signal activity detector circuitry configured to compare a level of the signal received from the signal path to a predefined threshold to determine if an input device is coupled to the signal path.

18. The PMIC of claim 17, wherein the signal received from the signal path is a signal output by an amplifier stage of the signal path or a signal output by an ADC stage of the signal path.

19. The PMIC of claim 2, wherein an instance of supply generator circuitry is configured to generate:
an output voltage for use as a supply voltage to an input device to the signal path; and/or
an output voltage for use as a supply voltage to an output device to the signal path.

20. The PMIC of claim 1, wherein the signal path comprises an audio signal path.

21. A system comprising the PMIC of claim 1 and an audio signal path.

22. An integrated circuit comprising the PMIC of claim 1 and an audio signal path.

23. A host device comprising the PMIC of claim 1.

24. The host device of claim 23, wherein the host device comprises: a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console, a VR or AR device, a mobile telephone, a portable audio player or other portable device; an audio mixing console, a public address (PA) system, an audio system of a performance venue, an audio system of a broadcasting or post-production studio, or professional audio system; a musical instrument; or an effects system for a musical instrument.

25. A power management integrated circuit (PMIC) for a system that comprises a signal path having a plurality of stages, the PMIC comprising:
supply generation circuitry for generating supply voltages for the stages of the signal path; and
controller circuitry configured to maintain the stages of the signal path in an inactive or low-power state until connection of an input device to the signal path is detected by the controller.

26. A power management integrated circuit (PMIC) for a system that comprises a plurality of independent signal paths, each independent signal path having a plurality of stages, the PMIC comprising:
supply generation circuitry for generating supply voltages for the stages of each signal path; and
controller circuitry configured to control operation of the supply generation circuitry, such that the supply voltages for the stages of each signal path of the plurality of signal paths are controllable independently of the supply voltages for the stages of each other signal path of the plurality of signal paths.
